(19) United States
(12) Patent Application Publication
(10) Pub. No.: US 2025/0288968 A1
(43) Pub. Date: Sep. 18, 2025

(54) APPARATUS FOR MIXING AND AGITATING ELECTRODE MATERIALS FOR SECONDARY BATTERY

(71) Applicant: SAMSUNG SDI CO., LTD., Yongin-si (KR)

(72) Inventor: Hyunjin Lee, Yongin-si (KR)

(21) Appl. No.: 18/803,303

(22) Filed: Aug. 13, 2024

(30) Foreign Application Priority Data
Mar. 12, 2024 (KR) 10-2024-0034440

(51) Int. Cl. B01F 35/51; B01F 27/90; B01F 35/214; B01F 35/32; B01F 101/59

(52) U.S. Cl. CPC B01F 35/51; B01F 27/90; B01F 35/214; B01F 35/3204; B01F 2101/59

(57) ABSTRACT

An apparatus for mixing and agitating electrode materials for a secondary battery includes: a vessel configured to accommodate materials for a secondary battery, the vessel including a transparent material such that an inside of the vessel is visible from the outside; an agitator configured to rotate and revolve within the vessel to mix and agitate the materials; a disperser configured to disperse the materials; and a driver housing accommodating driving parts that operate the agitator and the disperser.

### CROSS-REFERENCE TO RELATED APPLICATION

The present application claims priority to and the benefit of Korean Patent Application No. 10-2024-0034440, filed on Mar. 12, 2024, in the Korean Intellectual Property Office, the entire disclosure of which is incorporated herein by reference.

### BACKGROUND

### 1. Field

Aspects of embodiments of the present disclosure related to an apparatus for mixing and agitating electrode materials for a secondary battery.

### 2. Description of the Related Art

Different from a primary battery, which is not designed to be charged, a secondary battery is designed to be discharged and recharged. Generally, a secondary battery includes an electrode assembly including positive/negative electrode plates and a separator. The positive/negative electrode plates of the electrode assembly may be manufactured through various processes, such as press rolling, drying, slitting, and notching, after a process of coating an active material on a substrate. Materials for the electrode may include an active material, a binder, a solvent, etc.

A positive electrode material may include a lithium nickel-based oxide, a lithium cobalt-based oxide, a lithium manganese-based oxide, a lithium iron phosphate-based compound, a cobalt-free nickel-manganese-based oxide, a binder, and/or a conductive material. A negative electrode material may include crystalline carbon, such as natural graphite or synthetic graphite, soft carbon, hard carbon, mesophase pitch carbides, amorphous carbon, such as calcined coke, and silicon or a silicon-carbon complex.

The above information disclosed in this Background section is for enhancement of understanding of the background of the present disclosure, and therefore, it may contain information that does not constitute related (or prior) art.

### SUMMARY

Materials for manufacturing an electrode for a secondary battery should be uniformly mixed and agitated prior to application to a substrate, which may be done by a mixer. In a conventional method, the inside of the mixer cannot be seen, and even when the inside of the mixer is visible, the conventional method has many other limitations. In particular, it is difficult to monitor a process of mixing and agitation (collectively called “mixing”) being performed, and there is a limit in effectively establishing a mixing recipe.

Accordingly, various embodiments of the present disclosure provide a mixer apparatus in which mixing performed within a mixer can be easily monitored from the outside.

According to an embodiment of the present disclosure, an apparatus for mixing and agitating electrode materials for a secondary battery includes a vessel configured to accommodate materials for a secondary battery and including a transparent material so that the inside of the vessel is visible from the outside, an agitator configured to rotate and revolve within the vessel to mix and agitate the materials, a disperser configured to disperse the materials, and a driver housing accommodating driving parts that operate the agitator and the disperser.

Furthermore, according to another embodiment of the present disclosure, an apparatus for mixing and agitating electrode materials for a secondary battery includes a vessel configured to accommodate materials for a secondary battery and including a transparent vision window through which the inside of the vessel is visible from the outside, an agitator configured to rotate and revolve within the vessel to mix and agitate the materials, a disperser configured to disperse the materials, and a driver housing accommodating driving parts that operate the agitator and the disperser.

Aspects and features of the present disclosure are not limited to the above, and other aspects and features not specifically mentioned herein will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings:

FIG. 1 schematically illustrates an electrode assembly of a secondary battery.

FIG. 2 schematically illustrates a pouch-type secondary battery.

FIG. 3 is a cross-sectional view of a cylindrical secondary battery.

FIG. 4 is a cross-sectional view of a prismatic secondary battery.

FIG. 5 is a schematic diagram of a process of manufacturing an electrode plate of the electrode assembly illustrated in FIG. 1.

FIG. 6 is a schematic diagram of an apparatus for mixing and agitating electrode materials according to embodiments of the present disclosure.

FIG. 7 illustrates a mixer apparatus according to other embodiments.

FIG. 8 illustrates a mixer apparatus according to other embodiments.

FIG. 9 illustrates a modified embodiment of that shown in FIG. 6 in which a support structure is installed around a transparent vessel.

FIG. 10 illustrates a modified embodiment of that shown in FIG. 9 including an additional support to enhance the stiffness of the support structure.

FIG. 11 illustrates a modified embodiment of that shown in FIG. 10 including an additional support to enhance the stiffness of the support structure.

FIGS. 12A-12C are plan views describing a stereoscopic structure of the support structure according to different embodiments.

FIGS. 13A and 13B are conceptual diagrams of embodiments in which a camera has been installed in a vessel.

FIGS. 14A and 14B illustrate an embodiment of a vessel surface clean-up system.

FIGS. 15A and 15B illustrate other embodiments of a vessel surface clean-up system.

FIG. 16 is a perspective view of a secondary battery module according to one or more embodiments of the present disclosure.

FIG. 17 is a perspective view of a secondary battery pack including the secondary battery module illustrated in FIG. 16.

FIG. 18 is a conceptual view of a vehicle including the secondary battery pack illustrated in FIG. 17.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure with the understanding that an inventor can be his/her own lexicographer to appropriately define concepts of terms to describe his/her invention in the best way.

The embodiments described in this specification and the configurations illustrated in the drawings are only some of one or more embodiments of the present disclosure and do not represent all of the aspects of the present disclosure. Accordingly, it should be understood that there may be various equivalents and modifications that can replace or modify one or more embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

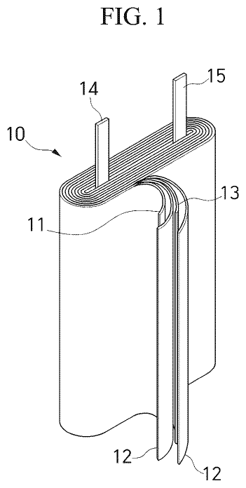

FIG. 1 is a schematic illustration of an electrode assembly of a secondary battery.

An electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction of the case 51. In other embodiments, the electrode assembly 10 may be a stack type rather than a winding type, but the shape of the electrode assembly 10 is not limited in the present disclosure. In addition, the electrode assembly 10 may be a Z-stack electrode assembly in which a positive electrode plate and a negative electrode plate are inserted into both sides of a separator, which is then bent (or folded) into a Z-stack. In addition, one or more electrode assemblies may be stacked such that long sides of the electrode assemblies are adjacent to each other and accommodated together in the case, and the number of electrode assemblies in the case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying a first electrode active material, such as graphite or carbon, to a first electrode substrate formed of a metal foil, such as copper, a copper alloy, nickel, or a nickel alloy. The first electrode plate 11 may include a second electrode tab 15 (e.g., a first uncoated portion) that is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying a second electrode active material, such as a transition metal oxide, on a second electrode substrate formed of a metal foil, such as aluminum or an aluminum alloy. The second electrode plate 13 may include a second electrode tab 15 (e.g., a second uncoated portion) that is a region to which the second electrode active material is not applied. The second electrode tab 15 may be connected to an external second terminal. In some embodiments, the second electrode tab 15 may be formed by being cut in advance to protrude to (or protrude from) the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

In some embodiments, the first electrode tab 14 may be located on the left side of the electrode assembly 10, and the second electrode tab 15 may be located on the right side of the electrode assembly 10. In other embodiments, the first electrode tab 14 and the second electrode tab 15 may be located on one side (e.g., the same side) of the electrode assembly 10 in the same direction.

Here, for convenience of description, the left and right sides are defined according to the electrode assembly 10 as oriented in FIG. 1, and the positions thereof may change when the secondary battery is rotated left and right or up and down.

The separator 12 prevents a short-circuit between the first electrode plate 11 and the second electrode plate 13 while allowing for movement of lithium ions therebetween. The separator 12 may be made of, for example, a polyethylene film, a polypropylene film, a polyethylene-polypropylene film, or the like.

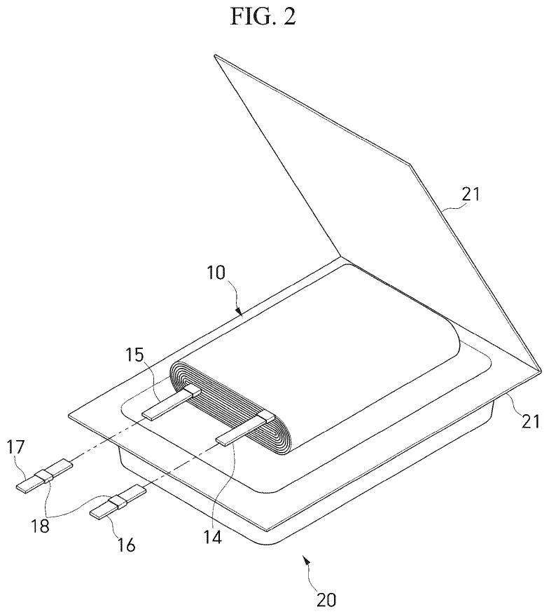

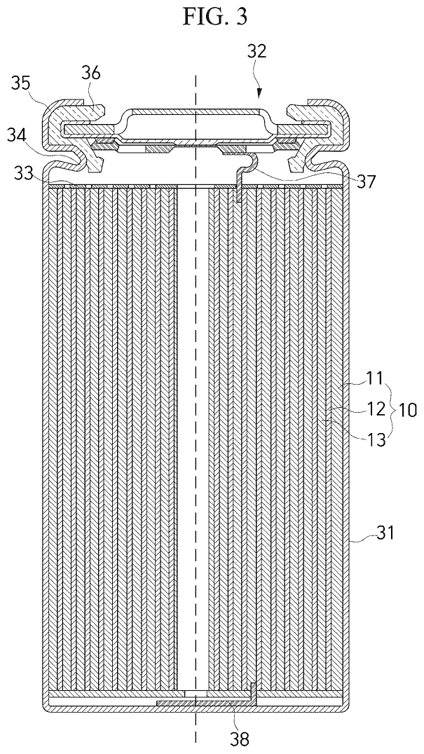

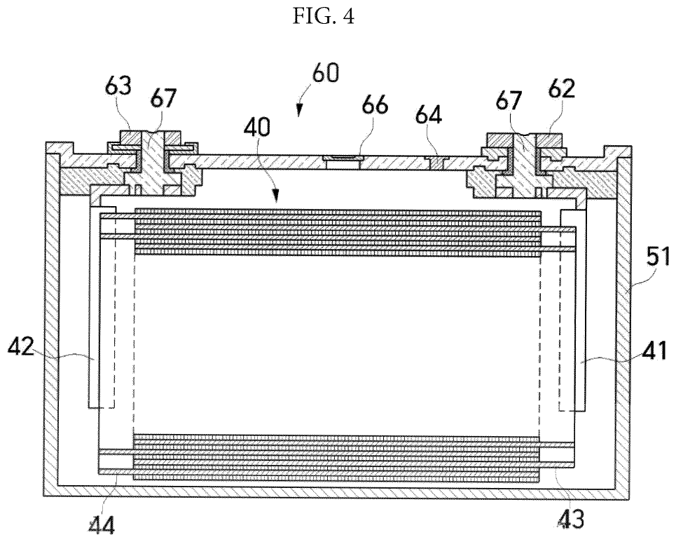

In some embodiments, the electrode assembly 10 may be accommodated in the case along with an electrolyte. In a pouch-type secondary battery, an electrode assembly 10 may be accommodated in a pouch made of a flexible material in the form illustrated in, for example, FIG. 2. In a cylindrical or prismatic secondary battery, an electrode assembly 10 may be accommodated in a cylindrical or prismatic metal casing in the form illustrated in, for example, FIGS. 3 and 4.

FIG. 2 schematically illustrates the pouch-type secondary battery.

The pouch-type secondary battery includes an electrode assembly 10 and a pouch 20 that accommodates the electrode assembly 10.

The electrode assembly 10 is the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may have a tab film 18 surrounding a portion thereof for insulation from the pouch 20.

The pouch 20 may be sealed by having sealing parts 21 at the edges thereof come into contact with each other while accommodating the electrode assembly 10 therein, in which case the sealing may be achieved with the tab film 18 interposed between the sealing parts 21. The sealing parts 21 of the pouch 20 may be made of a thermal fusion material that generally exhibits weak adhesion to metal. Thus, the pouch 20 may be fused by interposing the thin tab film 18 between the sealing parts 21 to improve adhesion at where the first terminal lead 16 and the second terminal lead 17 exit the pouch 20.

FIG. 3 illustrates a cylindrical secondary battery. As illustrated in FIG. 3, a secondary battery may include an electrode assembly 10, a case 31 accommodating the electrode assembly 10 and an electrolyte therein, a cap assembly 32 coupled to an opening in the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 32, forms the external appearance of the secondary battery. The case 31 may have a substantially cylindrical body portion and a bottom portion connected to one side (e.g., at one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of the gasket and the cap assembly 32 in the body portion. The crimping part 35 may firmly fix the cap assembly 32 by pressing the edge of the case 31 against the gasket 36. The case 31 may be formed of iron plated with nickel, for example.

The cap assembly 32 may be fixed to the inside of the crimping part 35 by a gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the casing 31.

FIG. 4 is a cross-sectional view of the prismatic secondary battery.

As illustrated in FIG. 4, a prismatic secondary battery may include an electrode assembly 40, a first current collector 41, a first terminal 62, a second current collector 42, a second terminal 63, a case 51, and a cap assembly 60.

An electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the case 51. In other embodiments, the electrode assembly 40 may be a stack type rather than a winding type, but the shape of the electrode assembly 40 is not limited in the present disclosure. In addition, the electrode assembly 40 may be a Z-stack electrode assembly in which a positive electrode plate and a negative electrode plate are inserted into both sides of a separator, which is then bent (or folded) into a Z-stack. In addition, one or more electrode assemblies may be stacked such that long sides of the electrode assemblies are adjacent to each other and accommodated together in the case, and the number of electrode assemblies in the case is not limited in the present disclosure. The first electrode plate of the electrode assembly may act as a negative electrode, and the second electrode plate may act as a positive electrode. Of course, the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As mentioned above, in some embodiments in which the first electrode tab 43 and the second electrode tab 44 are located at the top of the electrode assembly 40, the first and second current collectors are located at the top of the electrode assembly 40.

As illustrated in FIG. 4, the first current collector 41 and the second current collector 42 are connected to the first terminal 62 and the second terminal 63 through connection members 67, respectively. In some embodiments, each of the connection members 67 may have a threaded outer peripheral surface and may be fastened to the first terminal 62 and the second terminal 63 by screwing. However, the present disclosure is not limited thereto. For example, the connection members 67 may also be coupled to the first terminal 62 and the second terminal 63 by riveting or welding.

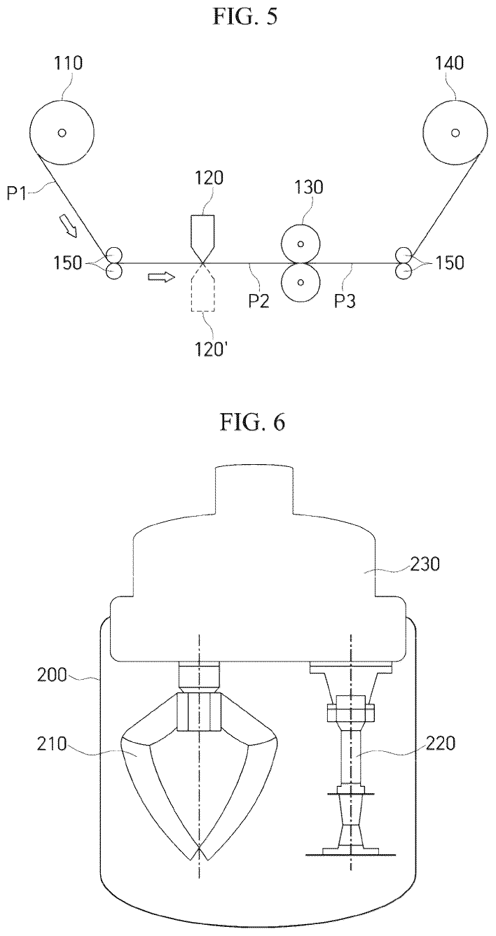

FIG. 5 is a schematic diagram describing a process for manufacturing the electrode plate (e.g., the first electrode plate 11 or the second electrode plate 13) of the electrode assembly 10 illustrated in FIG. 1.

A supply roll 110 is a roll on which a substrate P1 for an electrode plate is wound. When an apparatus for manufacturing electrode plates according to embodiments of the present disclosure is used to manufacture a positive electrode plate, the substrate P1 may be a metal foil containing aluminum (Al), for example. When the apparatus for manufacturing electrode plates according to embodiments of the present disclosure is used to manufacture a negative electrode plate, the substrate P1 may be a metal foil containing copper (Cu) or nickel (Ni), for example.

A transfer roller 150 may be an idle roller that guides the substrate P1 as it is unwound from the supply roll 110 or a drive roller that applies a pulling force to allow the substrate P1 to be unwound from the supply roll 110. FIG. 5 illustrates an embodiment including a total of four transfer rollers 150 as an example, but the number and positions of transfer rollers may be varied as needed.

A coating unit 120 forms a coating layer by coating the substrate P1 with a previously prepared electrode material slurry. In some embodiments, both surfaces, namely the upper and lower surfaces, of the substrate P1 may be concurrently or simultaneously coated by adding a second coating unit 120′, which has the same configuration as the coating unit 120 illustrated in FIG. 5, to the lower surface of the substrate P1.

The electrode materials to be coated may be in a slurry state in which an active material, a conductive material, a binder, other additives, and a solvent have been mixed or may be in a powder state in which an active material, a conductive material, a binder, and other additives have been mixed without a solvent. The active material may be a substance that activates an electrode reaction of a secondary battery in a positive electrode and a negative electrode. For example, the active material may refer to an active material that generates electric energy through a chemical reaction. The conductive material may be an additive substance for increasing the conductivity of an active material. The binder acts to fix or bond an active material to a substrate. Other additives are substances that are added for the purpose of a reduced charging speed, an improved energy density, and to provide a stabilized battery. The solvent may be a fluid to convert the active material, the conductive material, and/or other additives into the slurry state. From among processes of manufacturing electrode materials, a solvent may be used in a wet process but may not be used in a dry process.

A press unit (e.g., a roll-pressing unit) 130 includes (e.g., uses) a roll-pressing roller to compress an electrode plate P2 coated with slurry (a mixture of materials) by the coating unit 120 (e.g., the substrate P1 coated with the slurry by the coating unit 120) to produce a high-capacity and high-density secondary battery.

A winding roll 140 is a roll that winds and accommodates an electrode plate P3 coated and rolled by the coating unit 120 and the press unit 130 (e.g., the electrode plate P2 coated with the slurry by the coating unit 120 and pressed by the press unit 130).

In some embodiments, a drying unit may be added between the coating unit 120 and the winding roll 140 to dry or solidify the electrode plate P2 coated with the slurry. The drying unit may include a heat source. In addition, the drying unit may be physically separated from or otherwise functionally integrated into the press unit 130. For example, when the press unit 130 is configured in the form of a roller, the roller may be equipped with a heat source to simultaneously heat and roll the coating layer, thereby allowing the press unit 130 to be configured to also act as a drying unit.

Example materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni,

Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer disposed on the substrate. The positive electrode active material layer may include a positive electrode active material and may further include a binder and/or a conductive material.

The content of the positive electrode active material may be in a range of about 90 wt % to about 99.5 wt % on the basis of 100 wt % of the positive electrode active material layer, and the content of the binder and the conductive material may be in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). The separator may include polyethylene, polypropylene, polyvinylidene fluoride, or may be a multilayer film including two or more layers thereof.

The separator may include a porous substrate and a coating layer including an organic material, an inorganic material, or a combination thereof on one or both surfaces of the porous substrate.

The organic material may include a polyvinylidene fluoride-based polymer or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are laminated on each other.

FIG. 6 is a schematic diagram of an apparatus for mixing and agitating (hereinafter referred to as a “mixer” or a “mixer apparatus”) electrode materials according to some embodiments of the present disclosure. The mixer illustrated in FIG. 6 may be an example diagram of a planetary disperser (PD) mixer having both an agitator that mixes and agitates materials while performing rotation and orbit motions within a vessel and a disperser that disperses a mixed material at a high speed.

The mixer illustrated in FIG. 6 may include a vessel 200 in which mixing target materials are contained; an agitator 210 that mixes and agitates the materials while rotating and revolving within the vessel 200; a disperser 220 that disperses the materials in addition to the agitation of the agitator 210; and a driving part housing (e.g., a driver housing) 230 in which driving parts, such as a motor, an actuator, and a gear which drive the agitator 210 and the disperser 220, are accommodated (or housed).

Conventionally, the vessel 200 may be manufactured by using an opaque material (e.g., stainless steel or steel) and may have problems in that it is difficult to monitor a process of mixing being performed and to effectively establish a mixing recipe because the inside of the vessel cannot be seen during a mixing operation. Further, conventional mixing processes have many limits even if the inside of the vessel can be seen.

According to some embodiments of the present disclosure, the inside of the vessel 200 can be monitored during a mixing operation because the vessel 200 is manufactured by using a transparent material (e.g., engineering plastic). Accordingly, it is possible to check an internal operation situation and to effectively establish a mixing recipe even without opening the mixer by stopping a mixing operation.

In the embodiment shown in FIG. 6, the vessel 200 may be manufactured by using transparent engineering plastic.

Raw material resin for manufacturing the transparent vessel 200 may be selected from among PI, PC, PSU, PP, PE, PET, PET, PVC, PS, PMMA, and PCTFE. In some embodiments, the strength of the vessel 200 may be increased by adding fiber to the raw material resin. Fiber materials which may be added may be selected from among glass fiber, carbon fiber, aramid fiber, poly-p-phenylenebenzobisoxazole (PBO) fiber (e.g., Zylon fiber), and boron fiber.

A transmittance range T (%) of the vessel 200 may be in a range of about 5 to 100% with respect to light having a wavelength of about 550 nm. In some embodiments, a luminary may be installed inside and/or outside the vessel 200 to facilitate the monitoring of the inside of the vessel 200. In other embodiments, transmittance of the vessel 200 may be controlled by manufacturing the vessel 200 by using an electrochromic material.

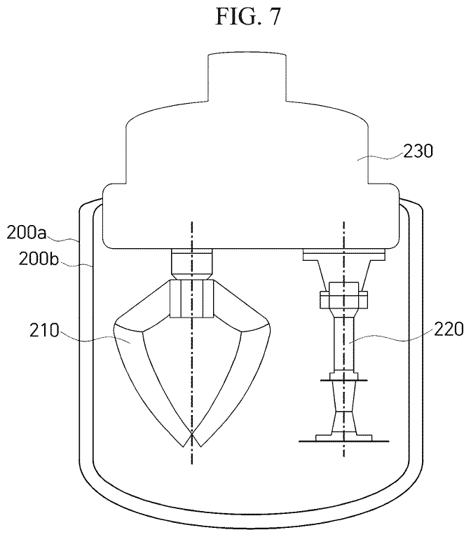

FIG. 7 illustrates a mixer apparatus according to other embodiments in which the vessel 200 has been manufactured to have a dual wall structure including a first transparent wall 200a and a second transparent wall 200b that is formed at an interval from (e.g., is spaced from) the first transparent wall 200a.

According to the illustrated embodiment, safety is increased because the stiffness of the vessel 200 having the first transparent wall 200a and the second transparent wall 200b is reinforced compared to the vessel 200 having the single wall structure shown in FIG. 6. Furthermore, a temperature within the vessel 200 can be maintained with less influence from the ambient environment (e.g., the ambient air temperature) due to an adiabatic action attributable to the air or other fluids between the first transparent wall 200a and the second transparent wall 200b.

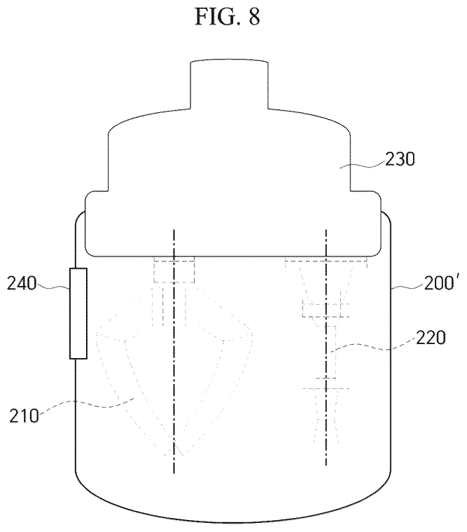

FIG. 8 illustrates a mixer apparatus according to other embodiments. According to the illustrated embodiment, a vessel 200′ may be manufactured by using an opaque material and including a transparent vision window 240 installed at least at one place in the vessel 200′ where monitoring is desired. Thus, a reduction of the stiffness of a vessel occurs when it is made plastic can be reduced or minimized by installing the vision window 240 only at one part of the vessel to monitor the inside of the vessel.

In some embodiments, the vision window 240 may have a dual wall structure including a first transparent wall and a second transparent wall that is formed at an interval from the first transparent wall.

A cover may be installed at (e.g., over) the vision window 240 so that the vision window can be opened always or only when desired. For example, if a material within the vessel 200′ can be influenced by external light, the vision window 240 may be covered with the cover, and the cover may be opened when the inside of the vessel is to be monitored. The cover may be installed such that it can be opened and/or closed manually or automatically. In the case of automatic opening and closing, an operator may open and close the cover by operating a motor or an actuator through a control panel.

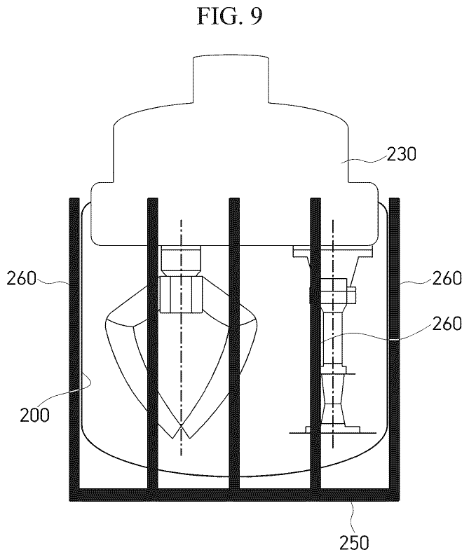

FIG. 9 illustrates an embodiment for protecting the vessel 200 against an external factor (e.g., a person, a robot, or a pile) by installing a support structure (e.g., a frame) around the transparent vessel 200 illustrated in FIG. 6.

The support structure for protecting the transparent vessel 200 may include a lower horizontal support 250 disposed at the bottom of the vessel 200 and multiple vertical supports 260 that are vertically connected to (e.g., vertically extend from) the lower horizontal support 250 and surround an outer surface of the vessel 200.

In various embodiments, 6 to 12 vertical supports 260 may be included and installed to surround a circumferential surface of the vessel 200.

At least one of the lower horizontal support 250 and the vertical supports 260 may have a cross section of a pipe having an empty inside and a diameter in a range of about 10 mm to about 50 mm, a pole having a filled inside, an L-shaped beam, or a “[”-shaped beam.

A material for at least one of the lower horizontal support 250 and the vertical supports 260 may be steel, a composite material, synthetic resin, or lumber.

A door, which may be opened or closed for accessibility to the vessel 200, may be installed at a part of the support structure, for example, the vertical support 260.

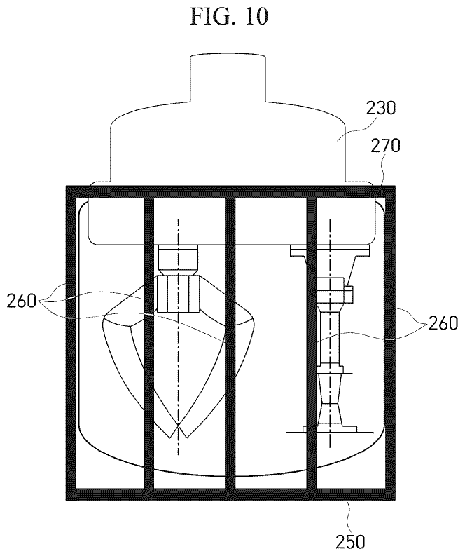

FIG. 10 illustrates an embodiment including an additional support to enhance the stiffness of the support structure shown in FIG. 9.

An upper horizontal support 270 that supports the top of the vertical supports 260 installed on the lower horizontal support 250 may be included to enhance structural firmness of the support structure. The upper horizontal support 270 may be manufactured by using the same material as the lower horizontal support 250 or the vertical supports 260 and may have the same shape as the lower horizontal support 250 or the vertical supports 260.

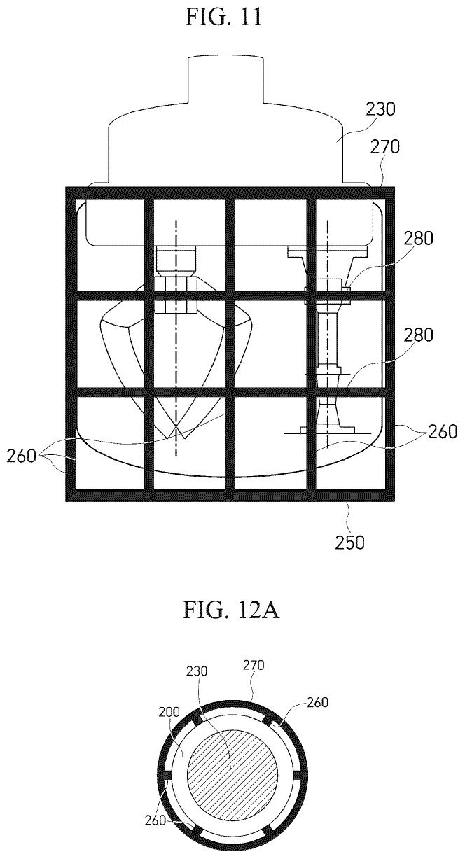

FIG. 11 illustrates an embodiment including additional supports to enhance the stiffness of the support structure shown in FIG. 10.

One or more middle horizontal supports 280 may be added between the lower horizontal support 250 and the upper horizontal support 270. The vertical supports 260 may be fixed to the lower horizontal support 250, the middle horizontal support(s) 280, and the upper horizontal support 270. Accordingly, the firmness of the support structure can be additionally enhanced.

Even in this embodiment, similar to the lower horizontal support 250, the upper horizontal support 270, and/or the vertical support 260, the middle horizontal support 280 may have a cross section of a pipe having an empty inside and a diameter in a range of about 10 mm to about 50 mm, a pole having a filled inside, an L-shaped beam, or a ⊏-shaped beam. Similarly, the middle horizontal support 280 may include steel, a composite material, synthetic resin, or lumber.

Furthermore, a door, which may be opened or closed to access the vessel 200, may be installed in the vertical support 260 and/or the middle horizontal support 280.

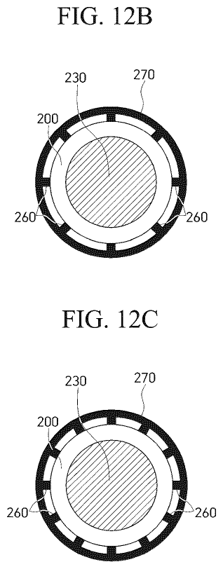

FIGS. 12A-12C are plan views describing a stereoscopic structure of the support structure. That is, FIGS. 12A-12C may be views from the top of the driving part housing 230. The driving part housing 230, the vessel 200, and the upper horizontal support 270 are disposed approximately in a concentric circle. The multiple vertical supports 260 have been installed between a circumferential surface of the vessel 200 and the upper horizontal support 270.

FIGS. 12A-12C illustrate embodiments in which the number of vertical supports 260 is 6, 8, and 12, respectively. Construction of the support structure for protecting the vessel 200 according to some embodiments of the present disclosure may be easily understood with reference to FIGS. 10-12C.

A camera may be installed to assist an interior vessel monitoring function.

The camera may be installed on an external surface of the transparent vessel 200 to monitor the inside of the vessel 200 through the vessel 200. To obtain a clearer image, the camera may be installed on an internal surface of the vessel 200.

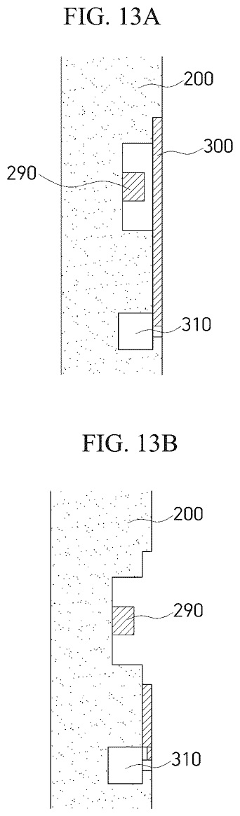

FIGS. 13A and 13B are schematic diagrams of embodiments in which a camera 290 is installed in the vessel 200 and illustrate a cross section of a wall of the vessel 200 in which the camera 290 has been installed on an internal surface of the vessel 200 to obtain a clearer image. FIG. 13A illustrates an embodiment in which a camera cover 300 is closed to block (e.g., to protect) the camera 290. FIG. 13B illustrates a state in which the camera cover 300 is open to open (e.g., to expose) the camera 290.

When the camera is installed on the internal surface of the vessel 200 as described above, the vessel may be constructed so that the cover of a lens can be opened when a mixing process is stopped because, otherwise, the camera 290 may be damaged or a scratch may occur on a surface of the lens due to a movement of an instrument within the vessel 200 during the mixing process.

A structure for installing the camera according to the illustrated embodiment may include the camera 290 buried and installed in the wall of the vessel 200, the camera cover 300 configured to move between opened and closed positions in front of the lens of the camera 290, and a motor or actuator 310 that moves the camera cover 300 to open and close the camera cover 300. Such components have been illustrated as being installed within the wall of the vessel 200 in FIGS. 13A and 13B, but the present disclosure is not limited thereto. For example, all of the camera 290, the camera cover 300, and the actuator 310 may be installed on an internal surface of the wall of the vessel 200. Some (e.g., the camera cover 300 and the actuator 310) of the components may be installed on the internal surface of the wall of the vessel 200, and other components (e.g., the camera 290) may be buried in the wall of the vessel 200.

The opening and closing of the camera cover 300 may be electrically controlled and may be operated by an operator or automatic control. For example, an operator may open and close the camera cover 300 by operating the actuator 310 by manipulating a control panel. In another embodiment, the actuator 310 may be automatically operated at a specific time by a processor for control, such as a microcontroller, to open or close the camera cover 300.

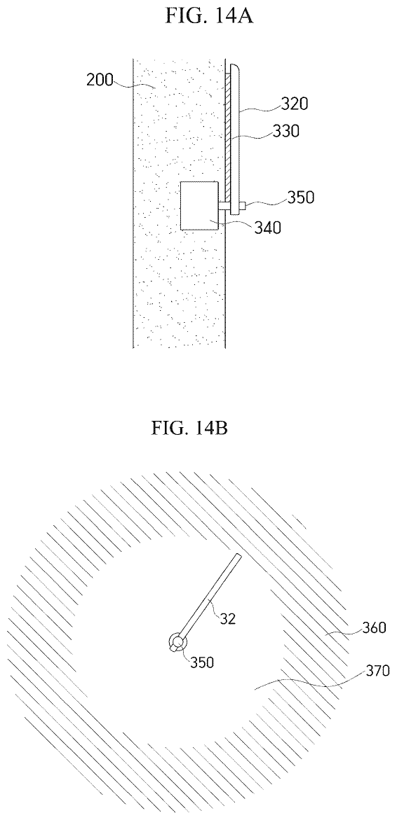

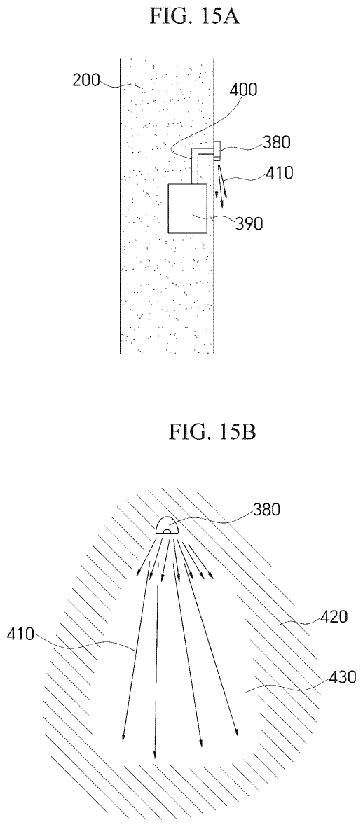

To provide the vessel inside monitoring function, measures against pollution or fogging on an internal surface of the transparent vessel 200 may be implemented. FIGS. 14A and 14B and 15A and 15B illustrate embodiments of such a vessel pollution removal system.

FIGS. 14A and 14B illustrate an embodiment in which a physical wiper is included.

Referring to FIG. 14A, the vessel pollution removal system according to the illustrated embodiment may include a motor 340 buried and installed in the wall of the vessel 200, a blade holder 320 coupled to a rotation shaft 350 of the motor 340 and rotated therewith, and a wiper blade 330 that is attached to the blade holder 320 and that wipes a surface of the vessel 200. In FIG. 14A, the motor 340 has been illustrated as being buried and installed in the wall of the vessel 200, but the present disclosure is not limited thereto.

FIG. 14B illustrates a fresh (e.g., clean or wiped) surface 370 from which pollution or fogging 360 on a surface of the vessel has been wiped and removed by the vessel pollution removal system.

An operation of the wiper blade 330 by the motor 340 may be electrically controlled and may be performed by an operator or automatic control. For example, an operator may rotate the wiper blade 330 by operating the motor 340 by manipulating a control panel. In another embodiment, the motor 340 may be automatically operated at a specific time by a processor for control, such as a microcontroller, so that the wiper blade 330 is rotated.

FIGS. 15A and 15B illustrate other embodiments of a vessel pollution removal system.

FIGS. 15A and 15B illustrate an embodiment in which pollution or fogging is removed by blowing the air on an internal wall of the vessel 200 by an air blower.

Referring to FIG. 15A, the vessel pollution removal system according to the illustrated embodiment may include a compressor 390 installed on (or in) the wall of the vessel 200 and a nozzle 380 that is connected to the compressor 390 through a hose (e.g., a tube or pipe) 400 and that is installed to spray the air on a surface of the wall of the vessel 200. In FIG. 15A, the compressor 390 is illustrated as being buried and installed in the wall of the vessel 200, but the present disclosure is not limited thereto.

FIG. 15B illustrates a fresh (e.g., a clean) surface 430 that is formed by blowing up (e.g., by blowing away) pollution or fogging 420 on a surface of the vessel y using air 410 that is sprayed by the nozzle 380 by using the vessel pollution removal system. Monitoring within the mixer can be more easily achieved by applying the vessel pollution removal system.

An operation of the compressor 390 that sprays the air through the nozzle 380 may be electrically controlled and may be performed by an operator or automatic control. For example, an operator may rotate the compressor 390 by manipulating a control panel. In another embodiment, the compressor 390 may be automatically operated at a specific time by a processor for control, such as a microcontroller, so that the air is sprayed through the nozzle 380.

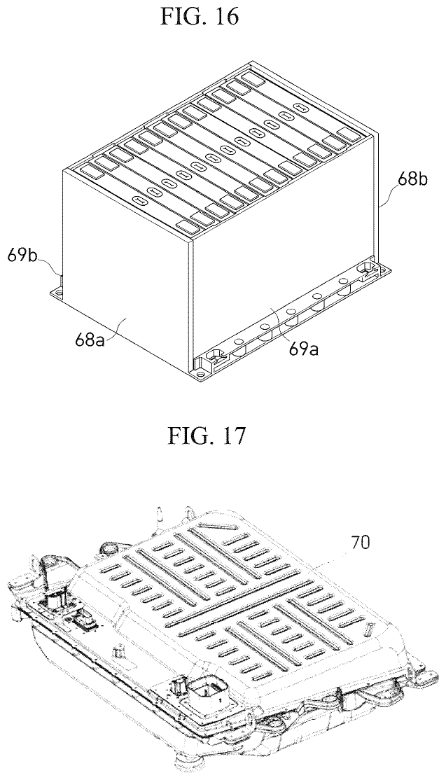

FIG. 16 is an schematic view of a secondary battery module in which prismatic secondary batteries are arranged according to embodiments of the present disclosure. With the increase in secondary battery capacity for driving electric vehicles or the like, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary battery module may be designed appropriately in arrangement (e.g., direction) and number of secondary batteries to obtain desired voltage and current specifications.

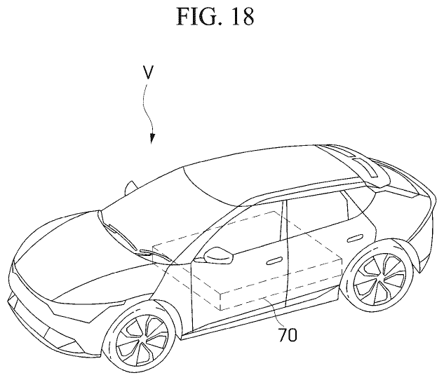

FIG. 17 is a view schematically showing a configuration of a battery pack 70 according to embodiments of the present disclosure. Referring to FIG. 17, a battery pack 70 may include an assembly to which individual batteries are electrically connected and a pack housing accommodating the same. In the drawings, for convenience of illustration, components including a bus bar, a cooling unit, external terminals for electrically connecting batteries, etc., are not illustrated.

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto. FIG. 18 shows a vehicle V that includes the battery pack 70 illustrated in FIG. 17 on the lower body thereof. The vehicle V may operate by (e.g., may be powered by) power from the battery pack 70.

Although the present disclosure has been described above with respect to embodiments thereof, the present disclosure is not limited thereto. Various modifications and variations can be made thereto by those skilled in the art within the spirit of the present disclosure and the scope of the appended claims and their equivalents.

According to embodiments of the present disclosure, the inside of the mixer can be easily monitored from the outside even without opening and checking the mixer because an aspect in which a material is input to the inside of the mixer, a movement or flow of the material after the input, and a change in the shape of a particle aggregate can be monitored. Accordingly, various mixing recipes for secondary battery products can be effectively established.

### DESCRIPTION OF SOME REFERENCE SYMBOLS

10: electrode assembly, 11: first electrode plate, 12: separator, 13: second electrode plate, 14: first electrode tab, 15: second electrode tab, 16: first terminal lead, 17: second terminal lead, 18: tab film, 20: pouch, 21: sealing part, 31: case, 32: cap assembly, 33: insulating plate, 34: beading part, 35: crimping part, 36: gasket, 37: first lead tab, 38: second lead tab, 40: electrode assembly, 41: first current collector, 42: second current collector, 43: first electrode tab, 44: second electrode tab, 51: case, 61: cap plate, 62: first terminal, 63: second terminal, 64: electrolyte injection hole, 65: notch, 66: vent, 67: connection member, 68a and 68b: end plate, 69a and 69b: side plate, 70: secondary battery pack, 110: supply roll, 120 and 120′: coating unit, 130: press unit, 140: winding roll, 150: transfer roller, 200: transparent vessel, 200′: opaque vessel, 200a: first transparent wall, 200b: second transparent wall, 210: agitator, 220: disperser, 230: driving part housing, 240: vision window, 250: lower horizontal support, 260: vertical support, 270: upper horizontal support, 280: middle horizontal support, 290: camera, 300: camera cover, 310: actuator, 320: blade holder, 330: wiper blade, 340: motor, 350: motor rotation shaft, 360: pollution or fogging part on surface of vessel, 370: fresh surface, 380: nozzle, 390: compressor, 400: hose, 420: pollution or fogging part on surface of vessel, 430: fresh surface, P1: substrate, P2: electrode plate on which electrode material has been coated, P3: electrode plate that has been press rolled, V: vehicle

What is claimed is:

1. An apparatus for mixing and agitating electrode materials for a secondary battery, the apparatus comprising:
a vessel configured to accommodate materials for a secondary battery, the vessel comprising a transparent material such that an inside of the vessel is visible from the outside;
an agitator configured to rotate and revolve within the vessel to mix and agitate the materials;
a disperser configured to disperse the materials; and
a driver housing accommodating driving parts that operate the agitator and the disperser.

2. The apparatus as claimed in claim 1, wherein the transparent material comprises one selected from among PI, PC, PSU, PP, PE, PET, PET, PVC, PS, PMMA, and PCTFE.

3. The apparatus as claimed in claim 1, wherein the vessel further comprises a material selected from among glass fiber, carbon fiber, aramid fiber, poly-p-phenylenebenzobisoxazole fiber, and boron fiber.

4. The apparatus as claimed in claim 1, wherein the vessel comprises an electrochromic material, and
wherein transmittance of the vessel is controlled by a voltage.

5. The apparatus as claimed in claim 1, wherein the vessel comprises:
a first transparent wall; and
a second transparent wall spaced apart from the first transparent wall to form a dual wall structure.

6. The apparatus as claimed in claim 1, further comprising a support structure comprising a lower horizontal support at a bottom of the vessel and vertical supports vertically extending from the lower horizontal support around an outer surface of the vessel.

7. The apparatus as claimed in claim 6, wherein at least one of the lower horizontal support and the vertical supports comprises a material selected from among steel, a composite material, synthetic resin, or lumber.

8. The apparatus as claimed in claim 6, wherein the support structure further comprises a door configured to be opened and closed to provide access to the vessel.

9. The apparatus as claimed in claim 6, wherein the support structure further comprises an upper horizontal support connected to a top of the vertical supports.

10. The apparatus as claimed in claim 9, wherein the support structure further comprises a middle horizontal support arranged between the lower horizontal support and the upper horizontal support.

11. The apparatus as claimed in claim 1, further comprising:
a camera configured to monitor the inside of the vessel;
a camera cover arranged in front of a lens of the camera and configured to move between opened and closed positions to selectively expose the lens of the camera; and
an actuator configured to move the camera cover between the opened and closed positions.

12. The apparatus as claimed in claim 1, further comprising a wiper blade configured to wipe an interior surface of the vessel.

13. The apparatus as claimed in claim 1, further comprising a nozzle configured to spray air on an interior surface of the vessel.

14. An apparatus for mixing and agitating electrode materials for a secondary battery, the apparatus comprising:
a vessel configured to accommodate materials for a secondary battery and comprising a transparent vision window through which an inside of the vessel is visible from the outside;
an agitator configured rotate and revolve within the vessel to mix and agitate the materials;
a disperser configured to disperse the materials; and
a driver housing accommodating driving parts that operate the agitator and the disperser.

15. The apparatus as claimed in claim 14, wherein the vision window comprises an electrochromic material, and
wherein transmittance of the vision window is controlled by a voltage.

16. The apparatus as claimed in claim 14, further comprising a cover configured to open or close the vision window.

17. The apparatus as claimed in claim 14, wherein the vision window comprises:
a first transparent wall; and
a second transparent wall spaced apart from the first transparent wall to form a dual wall structure.

18. The apparatus as claimed in claim 14, further comprising:
a camera configured to monitor the inside of the vessel;
a camera cover configured to move between opened or closed positions to expose a lens of the camera; and
an actuator configured to move the camera cover between the opened and closed positions.

19. The apparatus as claimed in claim 14, further comprising a wiper blade configured to wipe an interior surface of the vision window.

20. The apparatus as claimed in claim 14, further comprising a nozzle configured to spray air on an interior surface of the vision window.
